(19) United States
(12) Patent Application Publication
(10) Pub. No.: US 2024/0310216 A1
(43) Pub. Date: Sep. 19, 2024

(54) PROTECTIVE TUBE, TEMPERATURE SENSOR DEVICE WITH A PROTECTIVE TUBE AND DOUBLE-WALLED PIPE OR CONTAINER

(71) Applicant: WIKA Alexander Wiegand SE & Co. KG, Klingenberg (DE)

(72) Inventors: Jürgen Bräutigam, Elsenfeld (DE); Ulrich Thiel, Mömbris (DE); Martin Kullmann, Kleinwallstadt (DE)

(21) Appl. No.: 18/605,463

(22) Filed: Mar. 14, 2024

(30) Foreign Application Priority Data
Mar. 16, 2023 (DE) 10 2023 106 645.5
Mar. 14, 2024 (DE) 10 2024 107 222.9

(51) Int. Cl. G01K 1/08; B65D 81/38; F16L 41/00; F17C 3/08

(52) U.S. Cl. CPC G01K 1/08; B65D 81/38; F16L 41/008; F17C 3/08; F17C 2203/0391; F17C 2221/012; F17C 2223/0161; F17C 2250/0439; F17C 2250/0491

(57) ABSTRACT

The present disclosure relates to a protective tube with a protective tube body, a duct for inserting a measuring insert, a first connection part, which is designed for the direct or indirect closure of a first opening in an outer wall section of a double-walled pipe or a double-walled container, a second connection part, which is designed for the direct or indirect closure of a second opening in an inner wall section of the double-walled pipe or of the double-walled container, a ventilation device which is designed to release a connection line between an intermediate space between the outer wall section and the inner wall section and the duct in a first setting permeable to gas, and/or an access device, which is designed to release a connection line between an external environment and the duct in a first setting permeable to gas and to close it in a second setting, impermeable to gas.

### TECHNICAL FIELD

The present disclosure relates to a protective tube. The present disclosure also relates to a temperature sensor device with such a protective tube. Furthermore, the present disclosure relates to a double-walled pipe or a double-walled container.

Protective tubes are generally known in the state of the art and are partly also referred to as thermowells or pipe wells. They are used when a temperature sensor, for example a resistance thermometer or thermocouple sensor, is to be exposed to a measuring environment in which the temperature sensor is exposed to high mechanical, thermal, chemical or even other problematic environmental influences. Instead of directly introducing the temperature sensor into such an environment, the protective tube is directly exposed to the measuring environment and the temperature sensor is inserted into a duct inside the protective tube through an opening accessible from outside the measuring environment. In this context, the temperature sensor is also referred to as a measuring insert. The protective tube prevents direct exposure to the environmental influences of the sensor and thus protects it from damage. At the same time, the temperature sensor is thermally coupled to the measuring environment by the protective tube, so that temperature measurement is possible. An extended response time of the temperature sensor due to the thermal mass of the protective tube as well as a slight signal shift caused by a possible heat flow or heat gradient along the protective tube is accepted. In the following, the combination of a protective tube with a temperature sensor, which is inserted into the protective tube and is protected by it, is also referred to as a temperature sensor device.

The most important areas of application for protective tubes include pipelines and containers within which certain media (e.g. liquids, gas, powder, multiphase mixtures or other mixtures) are conveyed, stored and/or processed. In particular, with pipelines and containers that are part of process plants, this can also lead to strong flows, which correspondingly lead to mechanical loads.

In these areas of application, state-of-the-art protective tubes usually comprise an essentially cylindrical protective tube body, which extends between a distal end and a proximal end. The distal end is closed and facing the medium in the pipeline or container and, in particular, protrudes into the medium. The proximal end has a duct opening and is averted from the medium which is guided, stored or processed inside the pipeline or container. From the duct opening, a duct extends into the protective tube body, which runs through the protective tube body and ends at the closed distal end. This duct is used to accommodate a measuring insert, which is ideally inserted into the duct to such an extent that a temperature-sensitive measuring tip at the end of the measuring insert comes into contact with the closed distal end at the end of the duct. This ensures a good thermal coupling of the sensor to the medium.

Furthermore, such protective tubes include a connection part, which is arranged at or close to the proximal end of the protective tube body. In this context, an arrangement ‘at the proximal end’ should mean that the connection part is essentially flush with the proximal end of the protective tube body or that the connection part is essentially flush-connected to the proximal end of the protective tube body. Due to the wording ‘essentially’, in this context, possible arrangements should also be included which do not correspond to an exact flush joint or exact adjacency, but are characterized instead by a partial overlap of the parts. An arrangement ‘close to the proximal end’, on the other hand, should mean that the proximal end of the protective tube body protrudes beyond the connection part, but the connection part is at least closer to the proximal end than at the distal end or that a distance between the connection part and the proximal end is at least smaller than a distance between the proximal end and the distal end.

The connection part is used to close an opening in the pipeline or the container through which the protective tube, or more specifically the protective tube body, is inserted into the pipeline or container in a gas-impermeable, i.e. leak-tight, manner. This closure can be made directly at the opening, for example by the fact that the opening is provided with a female thread and the connection part has a matching male thread and a sealing face, which comes into a joint with a sealing face at the opening. Alternatively, the connection part can also have a corresponding geometry so that it can be welded directly into the opening. On the other hand, assemblies are often used in which the connection part closes the opening indirectly, with other components or parts also involved in the closure and scaling. For example, openings on pipelines or containers are often provided with a so-called neck tube, at the end of which a flange connection is provided. The connection part then includes a corresponding flange that can be connected to it. Neck tubes are usually welded to a wall section of the pipeline or container at the point of the opening.

Such protective tubes are thus designed to be connected to pipelines and containers, where the medium is enclosed by only one wall or where access to the medium is possible through a single opening, whereby only such a single opening must be sealed by the connection part of the surroundings.

New technical developments, especially in the field of transport, storage and/or processing of liquefied gases (low-temperature range, cryogenic) or liquefied solids, such as metal fusions or molten salt (maximum temperature range), but use multi-walled pipelines or containers where intermediate spaces are formed between the individual walls, which are evacuated, especially in low-temperature applications to reduce convection and condensation. Such systems place new demands on the design of temperature sensor devices or protective tubes.

Furthermore, the terms pipeline and pipe are used synonymously.

For example, DE 15 73 289 B describes a temperature probe assembly for an enameled double-walled container with a probe reaching into the inside of the container through an inner wall of the container. The probe can be fastened to the inner wall of the container by means of a flange engaging over one of the peripheral surfaces of the through-hole in the inner wall of the container and a fastening nut engaging over the other peripheral surface of the through-hole in the inner wall of the container. The probe has a flange-like collar in the area of its head section, which can be screwed onto a thread provided on the shaft part of the sensor from the outside of the inner wall of the container by means of a fastening nut on the inside of the inner wall of the container and can be clamped to the inner wall of the container. By means of this nut, a sealing bellows with an inside-facing end part and another end part, which is also flange-like, facing to the outside, with its inward-facing end section, can be attached to the inner wall of the container. The other end section of the sealing bellows can be fastened to the outside of the outer surface of the edge of a bore through the outer wall of the container.

Furthermore, from US 2022/0099502 A1 a thermocouple with low thermal conductivity and a heat sink package for electrically heated vacuum furnaces with fully reflective metal radiation shields or insulation packages are known.

DE 601 32 846 T2 describes a holding device for a measuring probe to determine the internal temperature of a container through the wall of the container. The holding device includes a localized deformation of the wall of the container in the form of a recess that does not pass through the wall and is facing towards the inside of the container. The cavity defines a hollow room on the outside of the container, which can accommodate a temperature measuring probe through contact against a wall. The wall of this mounting forms a temperature measuring area that is remote from the inside of the container.

### SUMMARY OF THE PRESENT DISCLOSURE

According to a first aspect of the present disclosure, a protective tube includes a protective tube body with a closed distal end and a proximal end, which has a duct opening, with the protective tube body extending between the distal and proximal ends.

When used on a double-walled pipe or container, i.e. when installed, as part of a temperature sensor device, the protective tube is aligned and positioned so that the distal end faces the interior of the pipeline or container, especially protrudes into the interior. The interior refers to the space within the double-walled pipe or double-walled container in which a medium whose temperature is to be measured is conveyed, stored and/or processed. The proximal end, on the other hand, is then facing towards an external environment that surrounds the double-walled pipe or container.

For the purpose of an unambiguous, clear description, it is assumed that the distal end of the protective tube body lies ‘at the bottom’ or ‘below’ the proximal end. The position of the proximal end is correspondingly referred to as ‘on top’ or ‘above’, at least in relation to the position of the distal end. The same should apply to a first connection part and a first opening (‘top’, ‘above’) and to a second connection part, a second opening and the medium inside the pipeline or container (‘bottom’, ‘below’), as defined in later sections. The thus given designation of orientations should apply accordingly to each part. So if one speaks in the following of a ‘top side’ or an ‘upper side’ of a certain part, then this refers to the side of the part which is closer to the proximal end, a first connection part, a first opening or the external environment than a side opposite this side of the part or an opposite end of the part. However, none of these terms, such as ‘top’, ‘bottom’, etc. implies that the part or side characterized with it must actually have this spatial orientation in a particular installation, especially in relation to some higher-level coordinate system. The terms are to be understood only relatively, to illustrate the arrangement and orientation of the components of the present present disclosure towards each other and among each other.

The protective tube body is designed in exemplary embodiments in a cylindrical shape. Alternatively, a tapered shape can be selected, whereby the diameter is reduced from the proximal to the distal end. In other embodiments, instead of a circular cross-section of the protective tube body, an oval or angular, in particular squared, cross-sectional shape can be selected.

The protective tube also has a duct, which starts at the duct opening, runs along the protective tube body and ends at the closed distal end with an end face. The duct can be formed, for example, by a blind bore in the protective tube body, if the protective tube body is made of bar stock material. Alternatively, the protective tube body can also be made of tubular material, whereby the tube is then sealed at the distal end by a suitable end cap or plate, in particular with a welded joint.

Through the duct opening, a measuring insert, i.e. a temperature sensor, can be inserted into the duct from outside the double-walled pipe or container until a temperature-sensitive measuring tip of the measuring insert comes into contact with the end face of the duct. Through the physical contact between the measuring tip and the end face, a reliable thermal coupling between the temperature sensor and the conducted or stored medium inside the double-walled pipe or double-walled container is possible, so that the temperature of the medium can be determined.

Furthermore, the protective tube includes a first connection part, which is arranged at or close to the proximal end of the protective tube body. In the context of this description, an arrangement ‘at the proximal end’ is intended to mean that a side of the connection part facing away from the double-walled pipe or container is at least substantially flush with the proximal end of the protective tube body or that the first connection part is at least substantially flush with the proximal end of the protective tube body. Due to the wording ‘essentially’, possible arrangements should also be included in this context, which do not correspond to an exact flush joint end and to an exact adjacent connection, but rather are marked instead by a partial overlap of the parts. In the context of this description, however, an arrangement ‘close to the proximal end’ should mean, that the connection part is located at least closer to the proximal than to the distal end of the protective tube body or that a distance between the first connecting section and the proximal end is at least smaller than a distance between the proximal and the distal end.

The first connection part is set up to close an opening in an outer wall section of the double-walled pipe or the double-walled container, directly or indirectly. The opening is necessary so that a temperature sensor can be inserted with a protective tube. In particular, the opening is closed by the first connection part in a gas-impermeable and pressure-resistant manner, so that an escape of the medium into the external environment is reliably prevented, even if the medium, due to a hole or crack on an inner wall section of the double-walled pipe or the double-walled container, would leave the inside and penetrate an intermediate space between the outer wall and the inner wall, and thus directly come into contact with the outer wall section.

From the state of the art, as already mentioned in previous sections, numerous possible designs for the first connection part are known. In the context of this description, an immediate closure of the opening is referred to as such closures which, through a direct interaction of the connection part and the opening or an opening edge area of the wall section, lead to a leak-tight connection. For such a direct closing, for example, screw connections or welded joints (so-called “weld-in” protective tubes, sometimes with weld stubs, also “socket weld”) are located between the connection part and the opening. In the context of this description, however, indirect closure of the opening refers to closures that are created by the interaction of the first connection part, the opening or the opening edge area and other components or parts. For example, openings on pipelines or containers are often provided with a so-called neck tube, at the end of which a device is arranged, which then comes into a direct connection with the first connection part of the protective tube. For example, the protective tube can have a first connection part with a corresponding contour and geometry, which is welded to the end of the neck tube (so-called “butt-weld” connection). Other possible designs of the connection part, which would be suitable for indirect closing of the opening in the context of this description, would be flanges or so-called Van-Stone connections, which can be connected correspondingly to a flange or clamp connection with union nut to the neck tube of the double-walled pipe or container. Neck tubes are usually welded to the outer wall section of the pipeline or the container at the point of the opening edge of the opening or at an opening edge area.

Furthermore, the protective tube comprises a second connection part, which is arranged at or close to the distal end. Analogous to the terminology explained with regard to the first connection part, an arrangement ‘at the distal end’ in the context of this description is intended to mean that a side of the connection part facing the interior of the double-walled pipe or container is at least substantially flush with the distal end of the protective tube body or that the second connection part is at least substantially flush with the distal end of the protective tube body. Due to the wording ‘essentially’, possible arrangements should also be included in this context, which do not correspond to an exact flush joint end and to an exact adjacent connection, but rather are characterized instead by a partial overlap of the parts. In the context of this description, however, an arrangement ‘close to the distal end’ is intended to mean that the connection part is arranged at least closer to the distal than to the proximal end of the protective tube body or that the second connection part is at least closer to the distal end than the first connection part.

The second connection part is designed to close an opening in an inner wall section of the double-walled pipe or the double-walled container directly or indirectly. Through the opening in the inner wall section of the pipe or container, it is possible for the distal end of the protective tube to come into direct contact with the medium whose temperature is to be measured. Thus, the protective tube can thermally couple a temperature-sensitive measuring tip of a temperature sensor inserted into the protective tube to the medium much better. This can reduce a response time of the sensor and improve a measurement accuracy. The second connection part ensures that the opening is, in particular, gas-impermeable and resistant to pressure, to reliably prevent the medium from escaping from the interior of the pipe or container.

For the purpose of clear designation, in the context of this document, the opening in the outer wall section is referred to as the first opening and the opening in the inner wall section is referred to as the second opening. Both the outer wall section or the outer wall as a whole, as well as the inner wall section or the inner wall as a whole, can generally have further openings if such are required for specific purposes in the respective application. However, such openings do not belong to the subject matter of the present present disclosure or its further training and variants. This means that the designation “first opening” does not imply that the outer wall section must include further openings (i.e. a “second” or “third”, etc.); neither does the term “second opening” imply that the inner wall section must include another, in particular a “first opening”.

Due to the first and second connection part, it is advantageously possible for protective tube to install safely at measuring points on double-walled pipelines or double-walled containers, without creating a weak point which would increase the risk of escaping of the medium from the interior of the pipe or container. The distal end of the protective tube can come into direct contact with the medium thanks to the second connection part, without the medium being able to escape from the interior of the container. At the same time, the duct opening, through which a temperature sensor can be inserted into the duct of the protective tube to the distal end, is accessible from outside the double-walled pipe or container. Thus, the temperature sensor can also be removed again, externally tested and reinserted or replaced, without the medium being able to escape. Thus, for the first time, the present protective tube is a protective tube, which can be used in the above-mentioned way on a double-walled pipe or double-walled container, thus reliably preventing the medium from escaping and at the same time being able to bring the distal end of the protective tube into direct contact with the medium.

According to the present disclosure, the protective tube includes a ventilation device. This is adapted to open a connection line between an intermediate space between the outer wall section and the inner wall section of the double-walled pipe or the double-walled container and the duct of the protective tube in a first setting so that it is permeable to gas and to close it tightly in a second setting so that it is impermeable to gas. The connection line can run directly between the intermediate space and the duct, or between the intermediate space and an internal space of the first connection part which is permanently connected to the duct, and thus indirectly between the intermediate space and the duct.

In particular, the connection line, which is released or blocked by the ventilation device, is the only intended fluid connection between the intermediate space and the duct. This means that if the ventilation device closes the connection line between the intermediate space and the duct, these two volumes are completely separated from each other in a gas-impermeable manner.

For example, the ventilation device can be designed within or at the first connection part and/or be formed within or at the protective tube body, especially close to the proximal end.

Embodiments of the protective tube with such a ventilation device can be particularly advantageously used in applications in which the space between the double-walled pipe or container is evacuated (in particular permanently evacuated by a vacuum pump) or is purged by a purge gas (in particular through an inert, highly dry purge or insulating gas). When used in such an application, i.e. in the installed state, as part of a temperature sensor device, when a temperature sensor is inserted into the duct and the duct is then sealed from the external environment by a closing device, which is explained in detail in a following section, the duct can be temporarily or permanently connected to the intermediate space in a gas-permeable manner by using the ventilation device. Once the intermediate space has been evacuated, the duct will also be evacuated. If the intermediate space is purged, the inside of the duct can also be purged. This enables chemical reactions and chemical impairments on the inner walls of the duct and also on the temperature sensor to be prevented in an advantageous way. In the event of evacuation, convection within the protective tube body or within the duct can also be reduced or excluded. In cryogenic applications, i.e. when, for example, liquefied gases are conducted, stored or processed within the double-walled pipe or double-walled container, it is also possible to effectively prevent the formation of condensation or ice within the duct.

If the temperature sensor should be removed in a later situation, the ventilation device can be closed again before removing the closing device and/or the temperature sensor. Thus, there is no longer any gas-permeable connection between the duct and the intermediate space and an atmosphere from the external environment cannot penetrate into the intermediate space.

For the previously mentioned purposes, the ventilation device, in an exemplary embodiment, includes a shut-off valve, which can be operated electronically or manually. In the case of a valve to be actuated manually, the ventilation device is designed in such a way that an actuation—i.e. a change in the setting from “open” to “closed” or vice versa—is possible from outside the double-walled pipe or container. The actuation can be carried out without tools, for example via a crankcase or a handle, or by means of a suitable tool. Thus, a simple and reliable actuation of the ventilation device is possible.

Furthermore, the ventilation device, in an exemplary embodiment of the protective tube, includes a duct system, which is formed within the first connection part and/or the protective tube body. The duct system is used to realize the connection line between the duct and the intermediate space. The duct system can be designed by bores within the first connection part and/or protective tube body, so that the connection line between the duct and the intermediate space can be particularly easily realized. A shut-off valve is provided within the duct system, through which the duct system can either be released in a gas-permeable manner or be closed impermeable to gas.

In another exemplary embodiment of the protective tube, the ventilation device includes a check valve, which is aligned in such a way that only a fluid flow is permitted from the duct in the direction of the intermediate space, while a fluid flow is shut off in the opposite direction. Thus, with the ventilation device open, the duct can be evacuated via the intermediate space (if the intermediate space is or is being evacuated). In the event of a defect, however, if the medium, for example, overcomes the inner wall of the double-walled pipe or container, it is prevented that the medium can also penetrate into the duct via the ventilation device. Thus, in this design, an operational safety of the protective tube can be further improved.

Alternatively, or in addition to the ventilation device, the protective tube includes an access device. This is designed to release a connection line between an external environment and the duct in a first setting permeable to gas and to close it in a second setting, impermeable to gas. The connection line can run directly between the external environment and the duct or between the external environment and an internal space of the first connection part that is permanently connected to the duct in a gas-permeable manner, and thus indirectly between the external environment and the duct.

In particular, the connection line which is released or blocked by the access device is the only intended fluid connection between the external environment and the duct. This means that if the access device closes the connection line between the external environment and the duct, these two volumes are completely isolated from each other in a gas-impermeable manner.

For example, the access device can be designed within or on the first connection part and/or be formed within or on the protective tube body, especially in the vicinity of the proximal end.

For example, a vacuum pump can be connected to the access device in an advantageous way. If the protective tube is in use, i.e. in the installed state (as part of a temperature sensor device), a temperature sensor is inserted into the duct and the duct is then sealed off from the external environment by a closing device, which will be explained in more detail in a subsequent section, the duct can thus be evacuated. This can prevent chemical reactions or impairments as well as the formation of condensation or ice within the protective tube body or duct, even if the distal end is in direct contact with a very hot or very cold medium inside the double-walled pipe or double-walled container.

Analogous to the embodiments explained in previous sections with a ventilation device, a shut-off valve and/or a duct system may be provided in embodiments of the protective tube with the access device to realize the two setting options with either gas-permeable connection or gas-impermeable and thus leak-tight separation of the duct from the external environment. Furthermore, the access device can include a self-scaling coupling, so that, for example, an external vacuum pump can be connected via a hose line with a corresponding counter coupling and safely disconnected again.

In an exemplary embodiment of the protective tube, the protective tube body is formed thin-walled, at least in sections, between the first connection part and the second connection part. ‘In sections’ means in this context, the protective tube body is completely, i.e., over its full circumference, designed thin-walled, at least along a defined longitudinal section along its extension. In exemplary embodiments which have a protective tube body with multiple protective tube body sections, as will be explained in more detail in the following sections, one of these protective tube body sections can be designed as a thin-walled protective tube body section. ‘Thin-walled’ means, in particular, that an average wall thickness of the protective tube body along this thin-walled section is formed, at most, half as strong or large as an average wall thickness of the protective tube body in the area of the distal end. In other exemplary designs, the wall thickness of the thin-walled section is a maximum of 25 percent, or a maximum of 5 percent, of the wall thickness in the area of the distal end.

The distal end of the protective tube body is in direct contact with the medium and, under certain circumstances, must withstand high mechanical, thermal and/or chemical loads. Therefore, a certain minimum wall thickness is required at this point, which must be adapted to the specifications of the respective application. However, between the first and second connection part, the protective tube body is not exposed to such challenging ambient influences, so that a lower wall thickness is sufficient here. Thus, through the at least sectional thin-walled design of the protective tube body, material and thus costs and weight can be saved in an advantageous manner. In addition, this reduces the cross-sectional area of the physical connection between the medium and the external environment provided by the protective tube body, whereby the heat conduction between the external environment and the medium can be drastically reduced. In low-temperature applications, less heat is thus introduced from the external environment. In highest-temperature applications, less heat is dissipated to the external environment.

In a further exemplary design of the protective tube, the protective tube body is designed to be elastically deformable between the first connection part and the second connecting section, at least in sections, and in particular formed at least in sections by a corrugated bellows or a diaphragm bellows. “In sections” is to be understood here analogously to the definition from the context of the aforementioned embodiment with a thin-walled protective tube body. In exemplary embodiments which have a protective tube body with multiple protective tube body sections, as will be explained in more detail in the following sections, one of these protective tube body sections can be designed as an elastically deformable protective tube body section. This design can also achieve the advantage of reduced heat conduction between the external environment and the medium, as already mentioned above, with regard to the embodiment with thin-walled protective tube body. For example, the elastically deformable section can be made of plastic, which has a lower thermal conduction coefficient than the protective tube, otherwise made of metallic materials. On the other hand, the elastically deformable section can also be formed through a section with a very thin wall thickness, in which case the argument relating to the previous embodiment applies again.

In exemplary embodiments, in which the elastically deformable section is formed by a corrugated or diaphragm bellows, the thermal conduction resistance can be further increased, since corrugated or diaphragm bellows can not only be designed with thin walls, but at the same time the distance along which the heat flow takes place is extended by the waveform or bellows shape.

In addition, the installation and use of the protective tube can be improved in this design: Through the elastically deformable section, a slight displacement in the position of the first opening and second opening can be compensated. The first opening does not have to lie exactly above the second opening in a plan view (looking vertically from outside at the first opening). In particular, this makes it easier to install the protective tube in a double-walled pipeline. Such double-walled pipelines are typically not preassembled as a whole, but are only successively assembled, inner pipe section by inner pipe section and outer pipe section by outer pipe section. Because of that, it is much more likely, that slight displacements or misalignments between the inner pipe (inner wall section) and outer pipe (outer wall section) may occur.

In another exemplary embodiment of the protective tube, the first connecting body has an internal space, an intermediate space opening and an outlet opening. The intermediate space opening connects the internal space with the intermediate space between the outer wall section and inner wall section of the double-walled pipe or double-walled container. The outlet opening, however, connects the internal space with the external environment. The protective tube body extends, starting from the distal end in the direction of the proximal end, at least as far as the intermediate space opening. A first connection is arranged at the intermediate space opening, which seals the intermediate space opening to a first longitudinal section of the protective tube body in a perfect gas-impermeable manner. Thus, the internal space is sealed and separated from the intermediate space and there is no gas-permeable connection between the internal space and the intermediate space via the intermediate space opening.

In a first exemplary design of this embodiment, the protective tube body enters through the intermediate space opening and extends at least through the internal space to the outlet opening. A second connection is arranged at the outlet opening, which seals the outlet opening to a second longitudinal section of the protective tube body in a gas-impermeable manner. Thus, the internal space is sealed and separated from the external environment and there is no gas-permeable connection between the internal space and the external environment via the outlet opening. In an area between the first longitudinal section and the second longitudinal section, the protective tube body has a lateral opening, through which the duct is connected to the internal space. The protective tube also includes a closing device, which is designed to close the duct directly or indirectly to the external environment, impermeable to gas. As described in more detail in the following sections, the closing device is logically only used when a measuring insert is already placed in the duct. In this context, ‘direct’ closure means that the closing device is positioned directly at the protective tube body or at its proximal end, for example directly at the duct opening. In an exemplary embodiment, the closing device can then be formed, for example, by a compression fitting, which establishes a tight clamp connection between the edge of the duct and a sheathed surface of the measuring insert. In this context, ‘indirect’ closure means that the closing device does not attach directly to the proximal end of the protective tube body in order to seal the duct against the external environment, but rather involve other parts for this closure and sealing. Thus, in an exemplary design, the closing device can be formed, for example, in the form of a cap, which is attached to the side of the first connection part facing the external environment and completely encloses the outlet opening and, if necessary, the proximal end of the protective tube body protruding from the outlet opening. To ensure that the measuring insert can still provide measuring signals from the inside of the chamber sealed in this way, signal lines or contacts of the measuring insert can be led out through appropriately sealed cable bushings or plated-through holes in the closing device.

In a second exemplary design of this embodiment, the protective tube body does not extend from the intermediate space opening through the entire internal space to the outlet opening. Instead, the proximal end only adjoins the internal space or the protective tube body only protrudes into the interior. Thus, the duct opening opens directly into the internal space and the duct is therefore directly connected to the interior in a gas-permeable manner. A lateral opening at the protective tube body is therefore not necessary to connect the duct and the internal space. In this embodiment of the protective tube, the closing device is adapted to close the duct and the internal space directly or indirectly against the external environment, in a manner impermeable to gas. In this context, ‘indirect’ and ‘direct’ closures are understood as equivalent to the definition of these terms, which has been declared in relation to the first-mentioned exemplary design of this embodiment. In an exemplary design, the closing device comprises a compression fitting which is arranged at the outlet opening and seals the outlet opening to an outer lateral surface of a measuring insert inserted through the outlet opening into the internal space and therein further into the duct.

Thus, in the two exemplary designs of this embodiment of the protective tube, the internal space of the first connection part is always in gas-permeable connection with the duct in the protective tube body, but at the same time these connected volumes are separated from the intermediate space as well as from the external environment and sealed reliably. This design can be manufactured simply and cost-effectively and requires only a few components. Thus, in an exemplary design of this design, the internal space, the intermediate space opening and the outlet opening can be formed by a single through-hole through the first connection part. In other exemplary designs, the first connection and/or the second connection and/or the closing device may be designed by compression fittings, in particular with wedge rings. Such connections are particularly advantageous, since they are also detachable and also have a certain flexibility and thus can compensate for a slight tilt between the protective tube body, the measuring insert and/or the first connection part.

In addition, protective tube in accordance with the two designs mentioned in this design can be combined particularly efficiently and easily with the features of the aforementioned embodiments with respect to the ventilation device and the access device. For example, the ventilation device can be designed within the first connection part, for example by means of suitable channel bores and a valve. Thus, this can then release a connection between the intermediate space and the internal space in a first setting permeable to gas and close it in a second setting, impermeable to gas. Since the internal space is permanently connected to the duct in both designs in a gas-permeable manner, it is then always released or closed to the duct. The same applies, for example, for an access device designed within the first connection part.

In a further exemplary embodiment of the protective tube, the protective tube body is designed in several parts. Each individual part or section of the protective tube body also includes a duct or a duct section, so that—as soon as all parts of the protective tube body are installed or fitted-all duct sections are also in a gas-permeable connection with each other and a measuring insert can be pushed through from the duct opening at the proximal end along all duct sections to the end face at the closed distal end.

Thus, the protective tube can be mounted more flexibly when installed as part of a temperature sensor device on a double-walled pipe or a double-walled container. It is also possible to easily install the protective tube, especially in places that are difficult to access or in applications where there is little distance between the inner and outer walls. In addition, such designs can be particularly easily combined with the preceding designs with thin-walled sections and/or elastically deformable sections.

In an exemplary design of this embodiment of the protective tube, the protective tube body, designed as comprising multiple parts, includes at least one first protective tube body section, which extends from at least the second connection part to the distal end. Thus, in the application, the first protective tube body section, in the built-in state, as part of a temperature sensor device, passes through a double-walled pipe or container in a submersible sleeve-like manner through the second opening and protrudes into the interior of the double-walled pipe or container, at least in sections. For example, the first protective tube body section is formed integrally with the second connection part or the first protective tube body section is connected to the second connection part by a welded connection. Thus, the second opening can be sealed reliably with the help of the second connection part and the associated first protective tube body section. At the same time, the distal end of the protective tube body protrudes directly into the interior of the double-walled pipe or container, so that a good thermal coupling to a medium guided inside, stored and/or to be processed is possible. The first protective tube section comprises a duct section, which is closed at the distal end by the end face and has an opening at an end of the first protective tube body section facing away from the distal end and towards the external environment.

In this design, the protective tube body further comprises at least a second protective tube body section, which extends from the second connection part or from an upper end of the first protective tube body section to the proximal end. The second protective tube body section is directly or indirectly connected to the first protective tube body section or to the second connection part, for example by a weld, solder, screw or clamp connection. This allows the protective tube body to be easily assembled, section by section, so that installation is possible even in installation situations that are difficult to access. The second protective tube body section comprises a duct section, which has an opening at both ends of the second protective tube body section—i.e. both at the end facing the distal end and at the end which faces the proximal end or forms it.

The first and second protective tube body sections, in an exemplary embodiment, are connected indirectly or directly to each other and are aligned to each other such that their respective duct sections overlap with each other exactly in cross-section. Thus, the entire duct, which is formed through the duct sections, is designed straight and without steps and without bends, so that a measuring insert can be inserted into the duct particularly easily. In alternative exemplary embodiments, the protective tube body sections and/or the duct sections formed in them do not overlap with each other exactly in cross-section. For example, at their interfaces, where the protective tube section meets, may only form a partial overlap and/or longitudinal axes of the duct sections are slightly tilted to each other. In such designs, the inner diameters of the duct sections are chosen so wide that a measuring insert can nevertheless be inserted through all sections to reach the closed distal end without touching the inner walls or edges.

In a further exemplary design of the protective tube, this includes an alignment device, which is arranged on the protective tube body along a third longitudinal section, which lies between the first connection part and the second connection part. The alignment device is designed to facilitate the positioning and alignment of the protective tube body when mounting the protective tube. For this purpose, the alignment device has a defined outer contour, which surrounds the protective tube body, at least in sections. This external contour is matched to a geometry and size of the first opening, for example with a small tolerance, so that the alignment device does not become jammed in the first opening.

The alignment device can completely enclose the protective tube body, for example in the form of a disc or flange-like structure. However, the alignment device must then be provided with through-holes so that the first opening is not already blocked or completely concealed by the alignment device-after all, this design should also be particularly compatible with the preceding design with a ventilation device. In addition, through a variety of through-holes, the thermal conductivity of the alignment device can be reduced, so that the heat flow through this component can be reduced.

Alternatively, the alignment device can only surround the protective tube body in sections, for example, through at least three support arms, which are arranged evenly along the circumference of the protective tube body, or through a spoke-like construction. In this way, it can also be advantageously achieved that the heat flow through the support device is as low as possible and, moreover, that the first opening is not completely concealed or blocked by the support device.

This design can significantly simplify the mounting of the protective tube to a double-walled pipe or container, in particular in conjunction with the aforementioned embodiment with a multi-part protective tube body, as explained in more detail in the following sections with respect to a temperature sensor device of a double-walled pipe or double-walled container.

With such a multi-part formation of the protective tube body, the alignment device is part of a first protective tube body section, in an exemplary design, whereby this first protective tube body section extends from the second connection part upwards, at least to the third longitudinal section and is integrally connected to the alignment device. Thus, a particularly stable arrangement of the protective tube can be achieved as part of a temperature sensor device on a double-walled pipe or container.

In a further exemplary design, the first connection part comprises a connecting part on one end, provided for the closure of the first opening. Furthermore, the first connection part comprises a neck tube and a flange formed at an upper end of the connecting part. In addition, the first connection part has a connection module which has a flange geometry corresponding to the flange and seals the neck tube tightly at the flange. This means that the neck tube and the flange formed at its upper end are part of the first connection part. The first opening, which is, for example, a simple hole, can be closed by welding the connecting part into it or on top of it.

The connecting part, for example, has multiple through-holes, so that an internal volume of the neck tube is always connected to the intermediate space in a gas-permeable manner. At the same time, the through-holes also increase the thermal conduction resistance of the connecting part, so that the medium in the application is better thermally isolated from the external environment.

The last-mentioned embodiment enables an easier mounting of the protective tube, whereby the first and second openings can be easily aligned to each other. Through the connections, the inner wall section and the outer wall section are also rigidly connected to each other via the protective tube body section. That provides for additional stability of the double-walled pipe or container and can simplify further mounting steps.

In another exemplary embodiment, the end face of the duct at the closed distal end of the protective tube body is formed in such a way that it corresponds, at least in sections, to the shape of a front face at a temperature-sensitive measuring tip of a measuring insert to be held in the canal. This enables the end face and front face to come into an areal contact, at least in sections. Due to the thus large direct contact surface between the measuring tip and the closed distal end of the protective tube body, a particularly effective thermal coupling can be achieved. A response time of the measuring insert can thus be reduced and a measurement accuracy can be increased.

In an exemplary design, which is based on this embodiment, the end face comprises a central area, which has a spherical segment shape. With a measuring insert, whose measuring tip has a spherical segment-shaped front face with identical radius, a consistently large contact surface can be designed between the front face and the end face. This is also the case if the measuring insert does not run parallel to the duct, i.e. hits the end face at an angle to a central surface normal. The height of the spherical segment formed by the end face is smaller than the radius of the spherical segment. This can prevent a cylindrical body of the measuring insert that adjoins the spherical segmental front face of the measuring insert to hit an edge of the end face if the measuring insert does not run parallel to the duct. In order to further reduce the risk of such an impact, a peripheral area of the end face may be provided, which has a conical shape, which, for example, merges tangentially into the spherical central area surface.

According to a second aspect of the present disclosure, a temperature sensor device for measuring a temperature of a medium has at least one measuring insert which is arranged in a protective tube formed in accordance with the first aspect of the present disclosure.

In accordance with a possible embodiment of the temperature sensor device, the measuring insert is inserted into the duct in such a way that a front face of the measuring insert is in thermal contact with the end face of the duct. In particular, the measuring insert is inserted into the duct through the duct opening at the proximal end of the protective tube body. Thus, the measuring insert is protected from direct mechanical or chemical loading through the medium by the protective tube, but is nevertheless thermally coupled to it, so that the temperature of the medium can be measured reliably and accurately.

In accordance with a further possible design of the temperature sensor device, the front face of the measuring insert and the end face of the duct touch. Here, too, the measuring insert is protected by the protective tube from direct mechanical or chemical damage through the medium, but is nevertheless thermally coupled to it, so that the temperature of the medium can be measured reliably and accurately.

According to a third aspect of the present disclosure, a double-walled pipe or container which carries, contains or processes a medium, comprises an outer wall section with a first opening, an inner wall section and aforementioned temperature sensor device.

The outer wall section is arranged between the inner wall section and an external environment, so that an intermediate space is formed between the wall sections. The outer wall section thus encloses the inner wall section, at least in sections, and separates it from the external environment. In the case of a double-walled pipe, for example, the outer wall section is thus provided by a section of the outer pipe and the inner wall section by a section of the inner pipe, which lies below the outer wall section.

An inner surface of the inner wall section, facing away from the intermediate space, is adjacent to an interior of the double-walled pipe or container in which the medium is stored or guided. In order to achieve the highest possible thermal insulation between the external environment and the medium, the outer and inner wall sections do not touch each other but are spaced apart from each other by the intermediate space. For example, the entire inner wall of the double-walled pipe or container is separated from the entire outer wall by the intermediate space, with the exception of possible supporting struts or support structures.

The inner wall section also has a second opening. The term ‘second’ opening is chosen here in favor of a clear distinction to the first opening of the outer wall section. This designation does not imply that the inner wall section must show other openings, nor that the present present disclosure is restricted to the existence of such further openings in the inner wall section. The same applies to the designation of the ‘first’ opening of the outer wall section: The outer wall section does not need include any further openings either and the present present disclosure is also not limited to the existence of such further openings.

The first connection part of the protective tube seals, immediately or indirectly, the first opening impermeable to gas, so that an atmosphere from the external environment cannot penetrate into the intermediate space and the medium cannot escape into the external environment even if it should penetrate the intermediate space due to damage to the inner wall.

The second connection part of the protective tube closes, directly or indirectly, the second opening impermeable to gas, so that the medium cannot penetrate the intermediate space through this opening and can thus be guided, stored or processed safely inside the double-walled container or double-walled pipe.

In an exemplary embodiment of the double-walled pipe or container, the intermediate space is evacuated and, in particular, permanently connected to a switched-on vacuum pump, so that the space between the space remains permanently evacuated. Thus, a particularly high thermal insulation can be achieved between the external environment and the medium. Furthermore, condensation, for example of humidity, within the intermediate space can be effectively prevented.

The protective tube includes a ventilation device, as already described with regard to the first aspect of the present disclosure, so that the duct within the protective tube body in which the measuring insert is positioned can be evacuated via the intermediate space. Thus, condensation and/or chemical reactions within the duct can also be advantageously prevented.

In exemplary designs of the double-walled pipe or container, the medium is either a cryogenic medium, i.e. one which is guided or stored at low temperatures, such as liquid gases, or the medium is a high-temperature medium, i.e. one which is conducted or stored at high temperatures, such as a metal melt or a molt of salt.

What both types of media have in common is that they must be shielded thermally from the external environment for efficient and safe conveying, storage and/or processing. At the same time, it is often critical to monitor the temperature of such media closely during their transport through pipelines or storage in containers. Both requirements can be reliably fulfilled by a double-walled pipe or a double-walled container in accordance with the present present disclosure and its embodiments. In particular, the different embodiments of the protective tube described in the previous sections may, when used as part of the temperature sensor device, have their beneficial effects.

### DESCRIPTION OF THE DRAWINGS

Exemplary embodiments of the present disclosure are explained in more detail below with reference to drawings, showing:

FIG. 1 schematically an exemplary design of a protective tube in cross-section,

FIG. 2 schematically an exemplary design of a protective tube in cross-section,

FIG. 3 schematically, in sections, an exemplary design of a double-walled container or double-walled pipe with a temperature sensor device in cross-section,

FIG. 4 schematically, in sections, another exemplary design of a double-walled container or double-walled pipe with a temperature sensor device in cross-section,

FIG. 5 schematically, in sections, another exemplary design of a double-walled container or double-walled pipe with a temperature sensor device in cross-section,

FIG. 6 schematically, in sections, an exemplary design of a distal end of a protective tube in cross-section,

FIG. 7A schematically, in sections, another exemplary design of a double-walled container or double-walled pipe with a temperature sensor device in cross-section,

FIG. 7B schematically the temperature sensor device in accordance with FIG. 7A in cross-section,

FIG. 8A schematically, in sections, another exemplary design of a double-walled container or double-walled pipe with a temperature sensor device in cross-section and

FIG. 8B schematically the temperature sensor device in accordance with FIG. 8A in cross-section.

Corresponding parts are provided with identical reference numbers in all figures.

### DETAILED DESCRIPTION

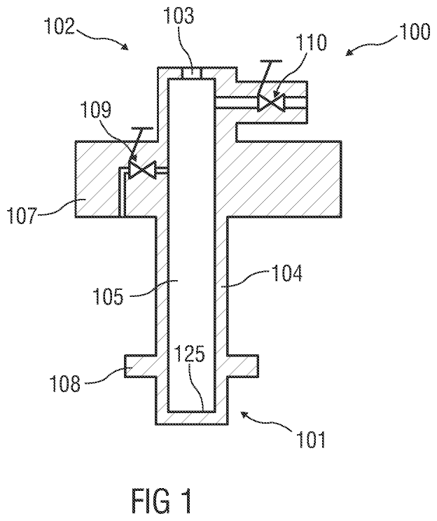

FIG. 1 schematically represents a cross-section of exemplary embodiment of a protective tube 100, which has a protective tube body 104 with a distal end 101 and a proximal end 102, whereby a first connection part 107 is arranged close to the proximal end 102 and a second connection part 108 is arranged close to the distal end 101. The proximal end 102 has a duct opening 103, to which a duct 105 is connected, which runs through the protective tube body 104 up to its distal end 101. At the distal end 101, however, the protective tube body 104 is closed, meaning that the duct 105 ends with an end face 125 at the distal end 101.

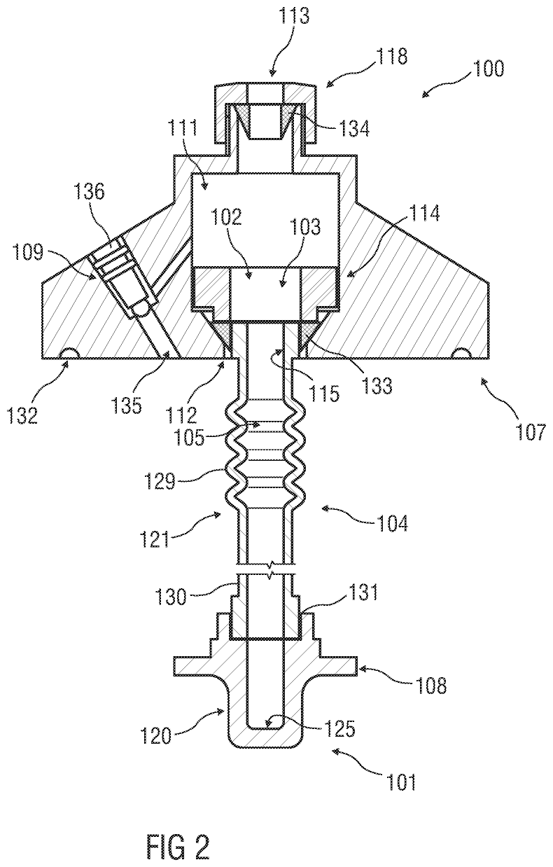

Furthermore, a ventilation device 109 is arranged at the proximal end 102, which is designed to open a connection line between an intermediate space 206, 206′, shown in more detail in FIG. 2, between an outer wall section 203, 203′ and an inner wall section 205, 205′ of the double-walled pipe 201 or the double-walled container 201′ (also shown in more detail in FIG. 2) and the duct 105 in a first setting so as to be permeable to gas and to close it in a second setting so as to be impermeable to gas.

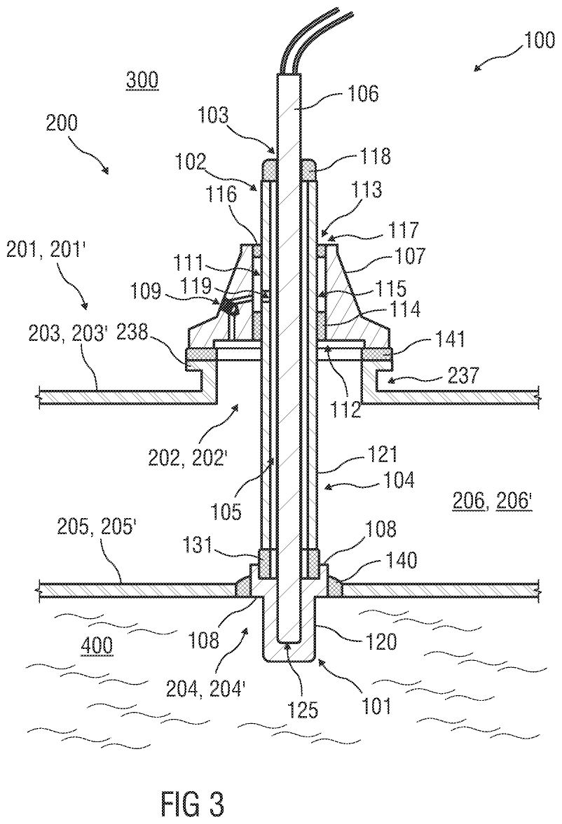

Alternatively or in addition to the ventilation device 109, an access device 110 is arranged at the proximal end 102, which is designed to open a connection line between an external environment 300 shown in more detail in FIG. 3 and the duct 105 in a gas-permeable manner in a first setting and to close it in a gas-impermeable manner in a second setting.

Terms such as ‘top, ‘bottom’, ‘above’, ‘below’, ‘right’ and ‘left’ in the following refer to the respective direction or arrangement within the respective drawing. For example, in all drawings, the distal end 101 is arranged below the proximal end 102.

FIG. 2 illustrates an exemplary embodiment of the protective tube 100. In this example, the protective tube body 104 has been designed in several parts. A first protective tube body section 120 forms the distal end 101 and the second connection part 108 is formed thereon. A second protective tube body section 121 is connected at a lower end to an upper end of the first protective tube body section 120 by a third connection 131, which is shown here by a soldered or welded connection. The second protective tube body section 121 then extends upwards in the direction of the first connection part 107. The second protective tube body section 121 has an elastically deformable protective tube body section 129 in a longitudinal section, which lies between its upper and lower end, which is shown as a corrugated bellows. The first connection part 107 includes an internal space 111 with a downward-facing intermediate space opening 112 and an upward-facing outlet opening 113. The second protective tube body section 121 extends to the intermediate space opening 112 and protrudes a bit into it. This upper end of the second protective tube body section 121 forms the proximal end 102 of the protective tube body 104. Through a first connection 114, the intermediate space opening 112 is sealed to an outer surface on a first longitudinal section 115 of the protective tube body 104. This first connection 114 is represented in this figure as a first ferrule 133 with a compression fitting. This embodiment has the advantage that, when secured, it achieves a high leak-tightness, but at the same time also has a certain flexibility and can also be loosened again. At the outlet opening 113, a corresponding compression fitting is also arranged with a second ferrule 134, which serves as the closing device 118. The closing device 118 can be used to seal the outlet opening 113 to an outer lateral surface of a measuring insert 106 inserted into the duct 105 and shown in more detail in FIG. 3. The first connection part 107 has a flange geometry with a sealing contour 132 on its underside. In this sealing contour 132, for example, a seal can be used, which can then seal against a corresponding flange geometry, which—as shown in more detail in FIG. 3—is provided at a first opening 202, 202′ in an outer wall section 203, 203′. Furthermore, the first connection part 107 features a ventilation device 109, which includes a duct system 135 and a valve 136 connected in series between two sections of the duct system 135. The duct system 135, on the one hand, opens into the internal space 111, on the other hand it has an opening, which is located at the bottom of the first connection part 107. The opening is located close to the intermediate space opening 112 within an area surrounded by the sealing contour 132. If the protective tube 100 is installed on a double-walled pipe 201 or a double-walled container 201′, an opening of the valve 136, which is shown here as a scaling body moving against a sealing seat, can open a gas-permeable connection between an intermediate space of 206, 206′ of the double-walled pipe 201 and the internal space 111.

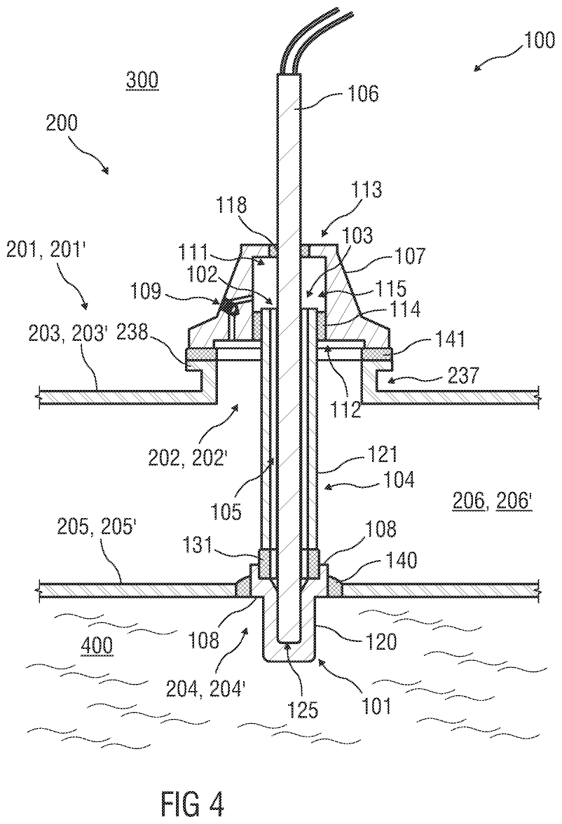

FIG. 3 and FIG. 4 each show schematically similar embodiments of a double-walled pipe 201 or double-walled container 201′ with a temperature sensor device 200 in cross-section. The temperature sensor devices 200 each comprise a protective tube 100 and a measuring insert 106. The double-walled pipe 201 or the double-walled container 201′ includes an inner wall section 205, 205′ which is part of an inner wall of the double-walled pipe 201 or the double-walled container 201′ and is adjacent to a medium 400, in particular encloses the medium 400. An outer wall section 203, 203′ is part of an outer wall of the double-walled pipe 201 or the double-walled container 201′ and is arranged between the inner wall section 205, 205′ and an external environment 300, so that between the inner wall and the outer wall—and thus also between the inner wall section 205, 205′ and the outer wall section 203, 203′—there is a intermediate space 206, 206′, by which the wall sections 205, 205′, 203, 203′ are separated from one another. For example, the intermediate space 206, 206′ is evacuated so that a high thermal insulation between the medium 400 and the external environment 300 is achieved.

In both Figures, the protective tube body 104 is designed in several parts, similar to FIG. 2. The first protective tube body section 120 forms the distal end 101 and has the second connection part 108 in the vicinity of the distal end 101. The second connection part 108 is connected circumferentially to the edge of a second opening 204, 204′ on the inner wall section 205, 205′ by a schematically shown fourth connection 140, so that the second opening 204, 204′ is closed and the medium 400 cannot penetrate into the intermediate space 206, 206′. The second protective tube body section 121 is connected to the first protective tube body section 120 by the schematically illustrated third connection 131, which extends upwards in the direction of the first connection part 107. The outer wall section 203, 203′ has a first opening 202, 202′, which is provided with a short neck tube 237 and a flange 238. Thus, the first connection part 107 can be connected to this opening in a simple and reliable way, as itself has a corresponding flange geometry. A schematically represented fifth connection 141, seals the two flange faces against each other, so that there is no gas-permeable connection between the intermediate space 206, 206′ and an external environment 300 via the first opening 202, 202.

The two designs differ in the sealing and/or connection concept of the protective tube 100:

In FIG. 3, the second protective tube body section 121 passes through the intermediate space opening 112, passes through internal space 111 and then also passes through the outlet opening 113. The schematically depicted first connection 114 seals the intermediate space opening 112 circumferentially to a lateral surface of the protective tube body 104 at a first longitudinal section 115, a schematically depicted second connection 116 in turn seals the outlet opening 113 circumferentially to a lateral surface of the protective tube body 104 at a second longitudinal section 117, and the schematically depicted closing device 118 in turn seals the duct opening 103 at the distal end against a lateral surface of the measuring insert 106. Thus, both of the duct 105 and the internal space 111 are sealed from the external environment 300 and from the intermediate space 206, 206′. Through a lateral opening 119, the internal space 111 and the duct 105 are in a gas-permeable connection. Thus, both volumes-insofar as the intermediate space 206, 206′ is evacuated—can also be evacuated by opening the ventilation device 109.

In the difference to FIG. 3, in FIG. 4, the second protective tube body section 121 (and thus the protective tube body 104) ends within the internal space 111 or only adjacent to it. The duct opening 103 thus opens into the internal space 111 and the closing device 118 seals the output opening 113 to a sheathed surface of the measuring insert 106. Also in this embodiment, it is advantageously achieved that duct 105 and internal space 111 are connected to each other in a gas-permeable manner, but are separated and sealed from intermediate space 206, 206′ and external environment 300.

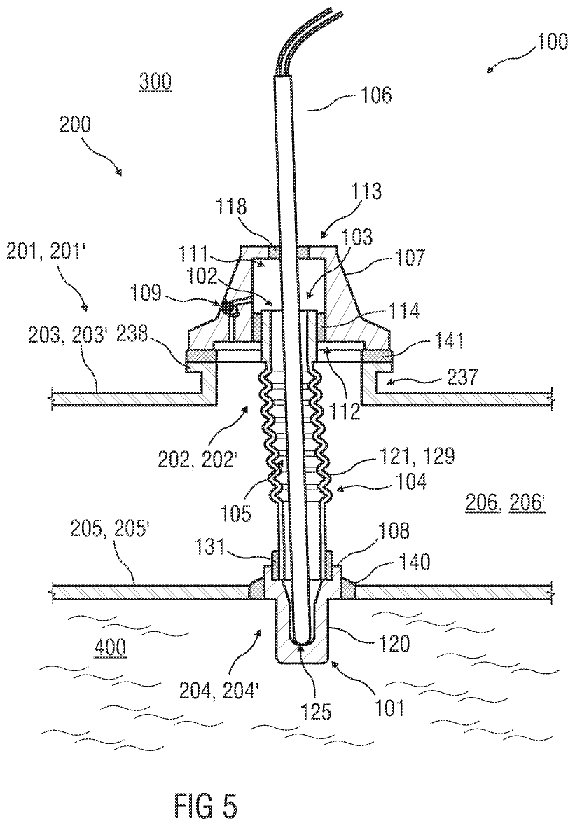

FIG. 5 shows another exemplary design of the double-walled pipe 201 or double-walled container 201′ with a temperature sensor device 200 in cross-section. The temperature sensor device 200 in this design comprises a protective tube 100, which is similar to that shown in FIG. 2. However, the connections 131, 140, 141, 114 and 118 are only shown in a simplified schematic way.

This figure illustrates an advantage of the embodiments with an elastically deformable protective tube body section 129: As can be seen in the drawing, the first opening 202, 202′ and the second opening 204, 204′ are not positioned on top of each other, but rather arranged slightly offset to each other. While a rigid protective tube body 104 would go crooked in such a situation, which would make a reliable sealing at connections 131 and 114 difficult, the elastically deformable protective tube body section 129 can easily compensate for this offset. At the same time, the duct 105 is so wide at all points that the measuring insert 106 can be inserted at the distal end 101, despite the inclined duct course up to the end face 125, without tilting. In order to create the largest possible contact surface between the end face 125 and a front face of 126 of the measuring insert 106—so that a good thermal coupling is possible—the end face 125 is matched to the shape of the front face 126.

In FIGS. 3, 4 and 5, the different connections 114, 116, 118, 131, 140 and 141 are merely schematically represented. In these drawings, a representation of the specific embodiments of the respective connections 114, 116, 118, 131, 140 and 141, as shown, for example, in FIGS. 2, 7 and 8, has been omitted in favor of illustrating more general concepts or other aspects. The connections 114, 116, 118, 131, 140 and 141 can, of course, be executed in different, specific ways, as also explained in the context of this document.

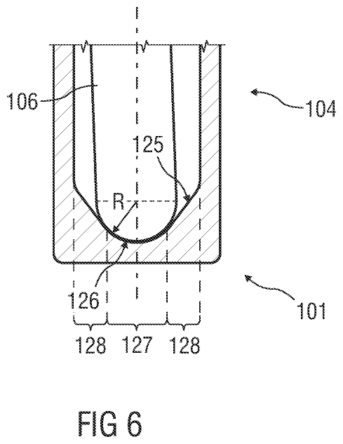

FIG. 6 shows the area of the end face 125 at the distal end 101 from FIG. 5 in an enlarged view. The front face 126 of the measuring insert 106 has a spherical surface with radius R. In this exemplary embodiment, the end face 125 includes a central area 127, which has a spherical segment shape with identical or almost identical radius R, and a peripheral area 128, which has a conical shape, which tangentially merges into the spherical segment surface. Through this shape, it is possible that, over a large area of different angles to a central surface normal of the end face 125, under which the measuring insert 106 can hit the end face 125, a large direct contact surface between the front face 126 and the end face 125 is achieved, without any tilting or tipping.

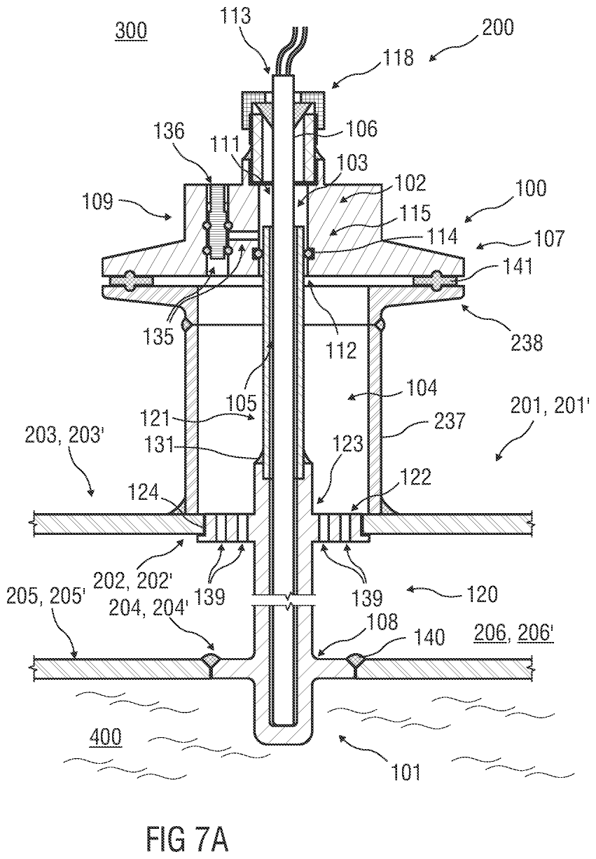

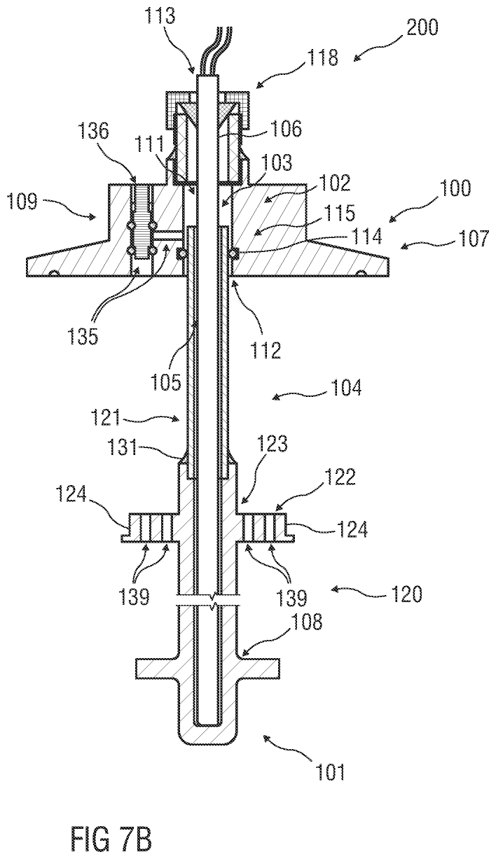

FIG. 7A shows an exemplary embodiment of the double-walled pipe 201 or double-walled container 201′ with a temperature sensor device 200 in cross-section. FIG. 7B shows the temperature sensor device 200 in accordance with FIG. 7A in cross-section.

This embodiment is similar to that from FIG. 4, where the third connection 131 is specifically designed as a weld or soldered connection, the fourth connection 140 is designed as a welded connection, the first connection 114 is designed by an O-ring seal and the closing device 118 includes a compression fitting, as already shown in FIG. 2. In addition, the protective tube body 104 includes a first protective tube body section 120, which has an alignment device 122. This is arranged along a third longitudinal section 123 and has a defined outer contour 124, which surrounds the protective tube body at least in sections. The defined outer contour is adapted to an inner diameter and/or an inner contour of the first opening 202, 202′, so that the alignment device 122 can be slid into the first opening 202, 202′ from below with a fit and thus provides an exact alignment of the first opening 202, 202′ relative to the second opening 204, 204′ or relatively to the protective tube body 104. The alignment device 122 has at least one through-hole 139, so that the intermediate space 206, 206′ is always permeable to gas with an internal volume of the neck tube 237. Furthermore, the protective tube body section 120 also has the second connection part 108. The protective tube body section 120 extends, in particular, from the distal end 101 to the third longitudinal section 123 and can be connected to the alignment device 122 and to the second connection part 108 integrally, as one piece.

This embodiment can be used particularly advantageously when connected to a double-walled pipe 201 as part of a temperature sensor device 200. The installation process can be considerably simplified, since when assembling double-walled pipes 201, inner pipe segments and outer pipe segments pushed over them are usually assembled piece by piece one after the other. With the help of the aligning device 122, a preassembly of a double-walled pipe section can be made easily, if the following steps are carried out:

First, the first protective tube body section 120, with its second connection part 108, is positioned at the second opening 204 and welded in there. Then the inner pipe section, which includes the inner wall section 205 with the second opening 204, together with the first protective tube body section 120, is inserted into a prepared outer pipe section, wherein the outer pipe section comprises the outer wall section 203, in which the first opening 202 is arranged. The inner pipe section and the outer pipe section are then aligned to each other in such a way that the alignment device 122 is inserted into the first opening 202 from below. As a result, the inner pipe section and the outer pipe section are in an optimal alignment to each other for further mounting of the temperature sensor device 200 and the assembly of the pipeline system can be continued. At a later time, when the inner pipe section and the outer pipe section have been integrated into a pipeline system, the remaining structure of the protective tube 100 can be carried out easily. Thus, for example, the second protective tube body section 121 is inserted from above into a holder provided for this purpose at the upper end of the first protective tube body section 120 and is leak-tightened there by a solder or welded connection 131. The first connection part 107 is then mounted from above and secured, for example by means of a flange clamp. This closes the first opening 202, wherein the first opening 202 can include a neck tube 237 and a flange 238.

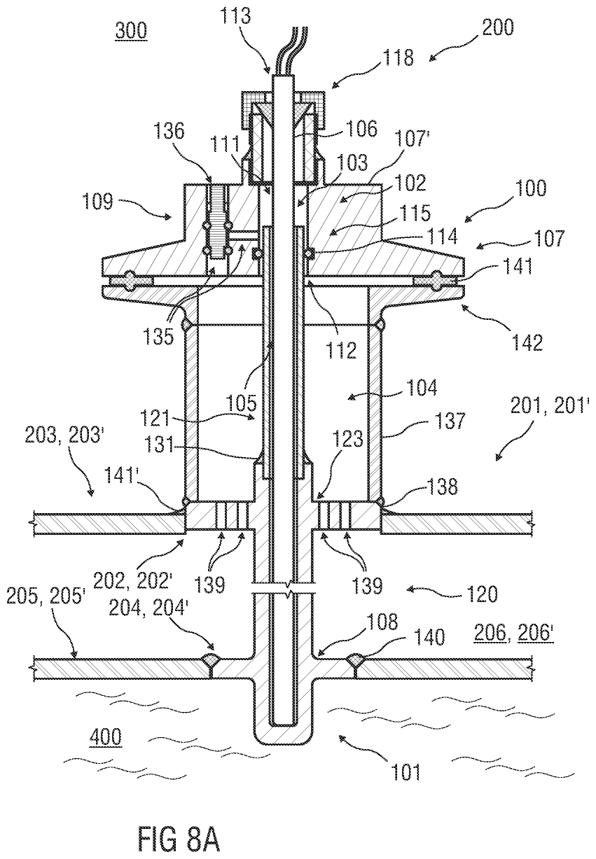

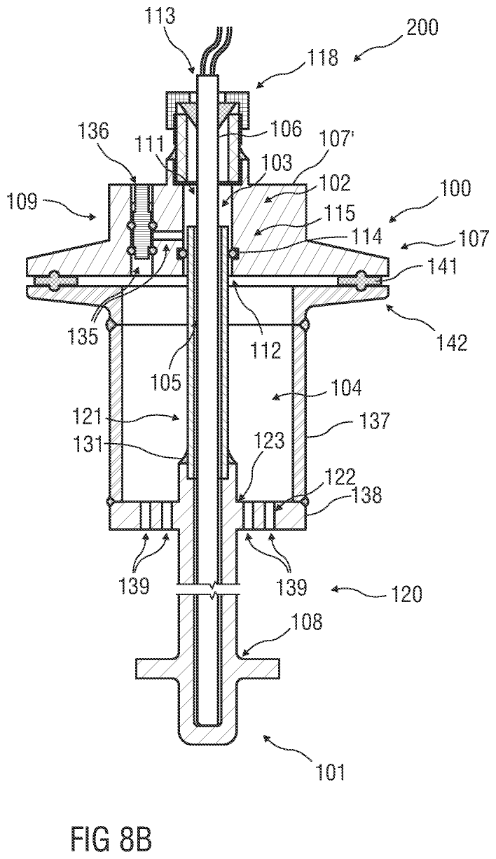

FIG. 8A shows a further exemplary embodiment of the double-walled pipe 201 or double-walled container 201′ with a temperature sensor device 200 in cross-section, which is similar to that from FIG. 7. FIG. 8B shows the temperature sensor device 200 schematically in accordance with FIG. 8A in cross-section.

In this embodiment, the first connection part 107 has a modular design. This means that, in contrast to the embodiment shown in FIG. 7, according to which the neck tube 237 and the flange 238 are parts of the first opening 202 of the double-walled pipe 201 or double-walled container 201′, the neck tube 137 and the flange 142 shown at its upper end belong to the first connection part 107. The first opening 202, 202′ is again reduced to a simple hole, which is closed by welding the connecting part 138. The aforementioned modularity refers to the fact that a first component of the first connection part 107 is provided by the connecting part 138, neck tube 137 and flange 142, and a second component is provided by a connection module 107′.

Viewed from bottom to top, the first connection part 107 starts with a connecting part 138, which is formed, for example, in the shape of a disk plate circumferentially on a first protective tube body section 120. The connecting part 138, for example, is arranged in the area of a third longitudinal section 123 of the protective tube body 104. For example, the protective tube body section 120 also includes the second connection part 108 and extends at least from the distal end 101 to the third longitudinal section 123 and can be connected as one-piece to the connecting part 138 and to the second connection part 108.

The connecting part 138 is designed to close the first opening 202, 202′. In the example shown, it is fixed directly in the first opening 202, 202′ through the connection 141′, whereby this can be, in particular, a welded connection. The neck tube 137 with flange 142 adjoins the connecting part 138 at the upper end. This is sealed tightly by a connection module 107′, which has a matching flange geometry. The connecting part 138 comprises multiple through-holes 139, so that an internal volume of the neck tube 137 is always in gas-permeable connection with the intermediate space 206, 206′. At the same time, the through-holes 139 also increase the thermal conduction resistance of the connecting part 138, so that the medium 400 is better thermally isolated from the external environment 300 in the application.

Similar to the embodiment shown in FIG. 7, the embodiment in accordance with FIG. 8 makes it easier to mount the protective tube 100. The first opening 202, 202′ and the second opening 204, 204′ can be easily aligned to each other. Due to the connections 140 and 141′, the inner wall section 205, 205′ and the outer wall section 203, 203′ are also permanently connected to each other via the protective tube body section 120, which gives the double-walled pipe 201 or the double-walled container 201′ additional stability and can simplify further mounting steps.

The present disclosure is not limited to the previous detailed embodiments. It can be modified to the extent of the following claims. Individual aspects from the subclaims can also be combined.

1. A protective tube, comprising:
a protective tube body which extends between a distal end and a proximal end, wherein the distal end is closed and the proximal end has a duct opening;
a duct for receiving a measuring insert, which starts at the duct opening, extends through the protective tube body and ends at the closed distal end with an end face;
a first connection part at or close to the proximal end, which is designed for the direct or indirect closure of a first opening in an outer wall section of a double-walled pipe or a double-walled container; and
a second connection part at or close to the distal end, which is designed for the direct or indirect closure of a second opening in an inner wall section of the double-walled pipe or of the double-walled container;
and including:
a ventilation device which is designed to open a connection line between an intermediate space between the outer wall section and the inner wall section of the double-walled pipe or of the double-walled container and the duct in a first setting so as to be permeable to gas and to close it in a second setting so as to be impermeable to gas; and/or
an access device, which is designed to release a connection line between an external environment and the duct in a first setting permeable to gas and to close it in a second setting, impermeable to gas.

2. The protective tube according to claim 1, wherein the protective tube body between the first connection part and the second connection part is thin-walled at least in sections, a wall thickness of the protective tube body in the thin-walled section corresponding in particular to at most 50 percent of the wall thickness of the protective tube body in a non-thin-walled section in the region of the distal end.

3. The protective tube according to claim 1, wherein the protective tube body between the first connection part and the second connection part is designed to be elastically deformable at least in sections, in particular is formed at least in sections by a corrugated bellows or a membrane bellows.

4. The protective tube according to claim 1, wherein the first connection part includes:
an internal space;
an intermediate space opening which connects the internal space with the intermediate space;
an outlet opening which connects the internal space with the external environment; and
a closing device;
wherein
the protective tube body at least extends to the intermediate space opening and a first connection seals the intermediate space opening to a first longitudinal section of the protective tube body impermeable to gas; and
wherein either
the protective tube body passages through the intermediate space opening and extends, at least through the internal space, to the outlet opening and a second connection seals the outlet opening to a second longitudinal section of the protective tube body entirely impermeable to gas;
the thermowell body in an area between the first longitudinal section and the second longitudinal section comprises a lateral opening, through which the duct is connected to the internal space in a gas-permeable manner; and
the closing device is designed to close the duct directly or indirectly against the external environment impermeable to gas;
or wherein
the proximal end adjoins or protrudes into the internal space so that the duct opening opens into the internal space and the duct is connected to the internal space in a gas-permeable manner; and
the closing device is designed to close the duct and the internal space directly or indirectly against the external environment in a gas-impermeable manner.

5. The protective tube according to claim 1, wherein the protective tube body comprises multiple parts or sections.

6. The protective tube of claim 5, further including:
a first protective tube body section of the protective tube body, which extends at least from the second connection part to the distal end and is designed to pass through the second opening and to project at least in sections into the interior of the double-walled pipe or the double-walled container;
a second protective tube body section of the protective tube body, which extends from the second connection part or an upper end of the first protective tube body section to the proximal end; and
wherein the second protective tube body section is directly or indirectly connected to the first protective tube body section or to the second connection part.

7. The protective tube according to claim 1, further including an alignment device, which is arranged on the protective tube body along a third longitudinal section, which lies between the first connection part and the second connection part, and has a defined outer contour, which surrounds the protective tube body circumferentially at least in sections.

8. The protective tube according to claim 1, wherein the first connection part includes:
a connecting part provided at an end for closing the first opening; and
a neck tube and a flange formed at an end facing away from the connecting part; and
a connection module which has a flange geometry corresponding to the flange and tightly closes the neck tube at the flange.

9. The protective tube according to one claim 1, wherein the end face of the duct at the closed distal end is shaped in such a way that it corresponds at least in sections to the shape of a front face of a measuring insert which can be accommodated in the duct.

10. The protective tube of claim 9, wherein the end face comprises a central area which has a spherical segment shape and, in particular, also includes an peripheral area, which has a conical shape, which merges into the tangential surface of the spherical segment.

11. The protective tube of claim 1 further including a temperature sensor device for measuring a temperature of a medium showing at least one measuring insert arranged in the protective tube.

12. The protective tube of claim 11, whereby the measuring insert is inserted into the duct in such a way that a front face of the measuring insert is in thermal contact with the end face of the duct.

13. The protective tube of claim 12, where the front face of the measuring insert and the end face of the duct touch.

14. A double-walled pipe or double-walled container for the guidance, storage and/or processing of a medium, comprising:
an outer wall section with a first opening;
an inner wall section; and
a temperature sensor device where:
an outer wall section is arranged between an inner wall section and an external environment, so that between the wall sections an intermediate space is formed; and
a side of the inner wall section facing away from the intermediate space adjoins an interior of the double-walled pipe or the double-walled
container, in which the medium is stored or guided;
wherein
the inner wall section has a second opening; and
the first connection part of a protective tube closes, directly or indirectly, the first opening in a gas-impermeable manner; and
the second connection part of the protective tube closes, directly or indirectly, the second opening in a gas-impermeable manner.

15. The double-walled pipe or double-walled container of claim 14, where the intermediate space is permanently connected to a vacuum pump for the purpose of evacuation and where the protective tube comprises a ventilation device, which is designed to release a connection line between the intermediate space and the duct in a first setting, permeable to gas, and to close it in a second setting, impermeable to gas.

16. The double-walled pipe or double-walled container of claim 14, wherein the medium:
is a cryogenic medium, in particular liquid hydrogen; or
is a high-temperature medium, especially a melt.
